(19) United States
(12) Patent Application Publication
(10) Pub. No.: US 2019/0335777 A1
(43) Pub. Date: Nov. 7, 2019

(54) COATED, CONTINUOUS OUTER-SKINNED FOOD PRODUCT AND PROCESS FOR MAKING THE SAME

(71) Applicants: Matthew L. Verhelle, Fenton, MI (US); Nancy R. Verhelle, Fenton, MI (US)

(72) Inventors: Matthew L. Verhelle, Fenton, MI (US); Nancy R. Verhelle, Fenton, MI (US)

(21) Appl. No.: 16/403,871

(22) Filed: May 6, 2019

Related U.S. Application Data
(60) Provisional application No. 62/666,731, filed on May 4, 2018.

(51) Int. Cl. A23B 7/16; A23G 1/30; A23L 19/00

(52) U.S. Cl. CPC A23B 7/16; A23V 2002/00; A23L 19/05; A23G 1/305

(57) ABSTRACT

A coated, continuous outer-skinned food product is provided. The coated, continuous skinned food product includes an outer skin having an exterior surface. A pulp portion is positioned internal to the outer skin and an inner core is positioned internal to the pulp portion. One or more layers of coating materials is applied to the exterior surface of the outer skin. The outer skin provides a continuous, uninterrupted protective layer enveloping the pulp portion and the inner core.

### CROSS-REFERENCE TO RELATED APPLICATIONS

This application claims the benefit of U.S. Provisional Patent Application No. 62/666,731, filed May 4, 2018, the disclosure of which is incorporated herein by reference in its entirety.

### BACKGROUND

Traditionally, coated fruits, such as for example, caramel coated apples, chocolate coated apples and candy coated apples (hereafter collectively referred to as “coated food product”) have utilized a handle, often in the form of a stick inserted into the coated food product. Prior to coating, the handle is configured to hold the food product as the food product is dipped in a coating material. The process of inserting the stick into the food product can pierce the product's skin, thereby allowing for the increased probability of foodborne illness through bacteria.

It is understood that coated and pierced food products, such as for example apples, are a perishable commodity and the shelf life of the coated and pierced food products can be limited due to the nature of the coated and pierced food product. It is also understood that piercing the skin of the food product begins the process of food product degradation and causes a reduction in the shelf life of the coated food product. When handled correctly, an unpierced and uncovered food product, such as for example an apple, stored in a cool and controlled environment, can have a shelf life of up to six months in storage. However, when the apple is pierced during the dipping and covering process, the shelf life can be greatly reduced to only a few weeks.

It would be advantageous to provide a coated, continuous outer-skinned food product having a longer shelf life.

### SUMMARY

It should be appreciated that this Summary is provided to introduce a selection of concepts in a simplified form, the concepts being further described below in the Detailed Description. This Summary is not intended to identify key features or essential features of this disclosure, not is it intended to limit the scope of the coated, continuous outer-skinned food product.

The above objects as well as other objects not specifically enumerated are achieved by a coated, continuous outer-skinned food product. The coated, continuous skinned food product includes an outer skin having an exterior surface. A pulp portion is positioned internal to the outer skin and an inner core is positioned internal to the pulp portion. One or more layers of coating materials is applied to the exterior surface of the outer skin. The outer skin provides a continuous, uninterrupted protective layer enveloping the pulp portion and the inner core.

Various objects and advantages of the coated, continuous outer-skinned food product will become apparent to those skilled in the art from the following detailed description, when read in light of the accompanying drawings.

### BRIEF DESCRIPTION OF THE DRAWINGS

FIG. 1 is a perspective view of a non-limiting embodiment of a conventional food product prior to coating with a coating material.

FIG. 2 is a perspective view of the conventional food product of FIG. 1 coated with a conventional coating material.

FIG. 3 is a perspective, cross-sectional view of the conventional food product of FIG. 1.

FIG. 4 is a perspective, cross-sectional view of the conventional food product of FIG. 2 illustrating a passage formed within the conventional food product by a handle.

FIG. 5 is a perspective view of an improved, coated, continuous outer-skinned food product.

FIG. 6 is a perspective, cross-sectional view of the improved, coated, continuous outer-skinned food product of FIG. 5 illustrating the lack of a passage formed within the food product by a handle.

FIG. 7 is a flow chart illustrating the process steps of making the improved, coated, continuous outer-skinned food product of FIG. 5.

### DETAILED DESCRIPTION

The coated, continuous outer-skinned food product will now be described with occasional reference to the illustrated embodiments. The coated, continuous outer skinned food product may, however, be embodied in different forms and should not be construed as limited to the embodiments set forth herein. Rather, these embodiments are provided so that this disclosure will be thorough and complete, and will fully convey the scope of the coated, continuous outer-skinned food product to those skilled in the art.

Unless otherwise defined, all technical and scientific terms used herein have the same meaning as commonly understood by one of ordinary skill in the art to which the coated, continuous outer-skinned food product belongs. The terminology used in the description of the coated, continuous outer-skinned food product herein is for describing particular embodiments only and is not intended to be limiting of the coated, continuous outer-skinned food product. As used in the description of the coated, continuous outer-skinned food product and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the coated, continuous outer-skinned food product. Notwithstanding that the numerical ranges and parameters setting forth the broad scope of the coated, continuous outer skinned food product are approximations, the numerical values set forth in the specific examples are reported as precisely as possible. Any numerical values, however, inherently contain certain errors necessarily resulting from error found in their respective measurements.

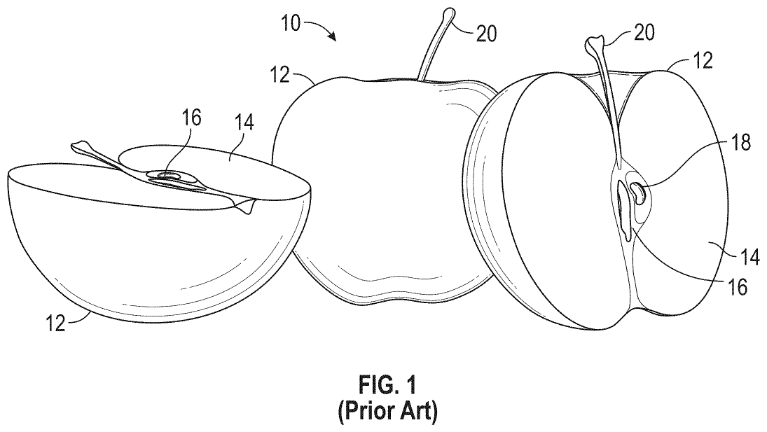

Referring now to FIG. 1, one non-limiting embodiment of a conventional food product, prior to coating, is shown generally at 10. The term “food product”, as used herein, is defined to mean any edible structure having an outer skin configured to protect an inner core, with the inner core being substantially enveloped by a pulp portion.

Referring again to FIG. 1, the conventional food product 10 includes an outer skin 12, a pulp portion 14 located under the outer skin 12 and adjacent an inner core 16. A plurality of seeds 18 is located within the inner core 16 and a stem 20 extends outward from the inner core 16. The term “outer skin” (also called the “exocarp”), as used herein, is defined to mean any layer external to the pulp portion and configured to protect the inner core and the pulp portion. Typically, the outer skin can be peeled off to expose the pulp portion. The term “pulp portion” (also called the “mesocarp”), as used herein, is defined to mean any portion of the food product positioned between the outer skin and the inner core. Typically, the pulp portion is edible. The term “inner core” (also called the “endocarp”), as used herein, is defined to mean any innermost layer of the food product which surrounds one or more seeds. The structure of the inner core may be membranous or woody. The term “stem” (also called the “stalk”), as used herein, is defined to mean any structure connected to and extending from the inner core and configured to attach to a support structure. Non-limiting examples of a support structure include trees, bushes, plants and the like. In the illustrated embodiment, the food product 10 is an apple. However, it should be appreciated that in other embodiments, the food product can have other forms, including the non-limiting examples of pears, strawberries, bananas, kiwi and the like.

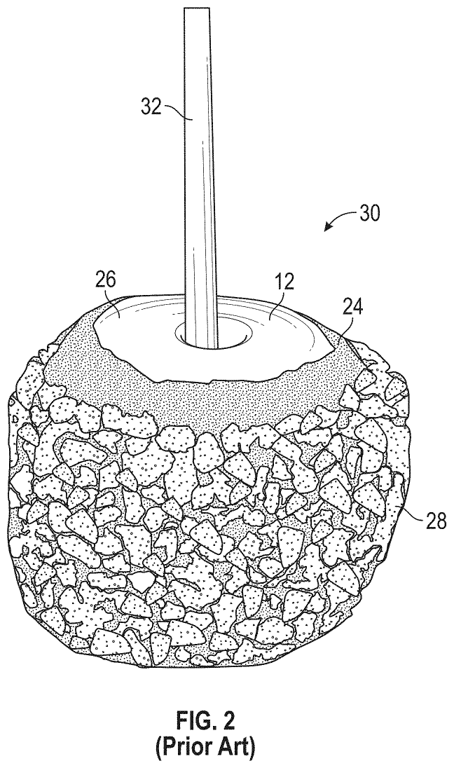

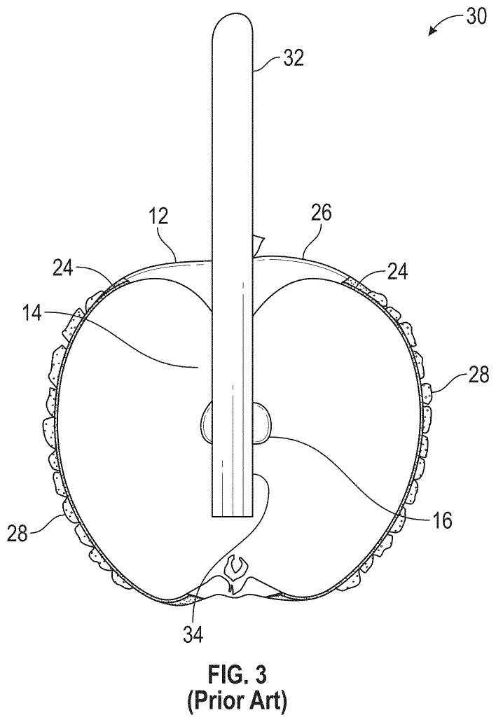

Referring now to FIGS. 2 and 3, one non-limiting example of the conventional food product 10 illustrated in FIG. 1 is shown with a conventional coating material 24 applied to an exterior surface 26 of the outer skin 12, thereby forming a conventional coated food product 30. The term “coating material”, as used herein, is defined to mean any layer of edible material applied to an exterior surface of the outer skin 12 of the food product. In the illustrated embodiment, the coating material 24 has the form of a caramel-based material. However, in other embodiments, the coating material 24 can have other conventional forms, including the non-limiting examples of chocolate or candy. In still other embodiments, more than one coating material 24 can be applied to the exterior surface 26 of the outer skin 12.

Referring again to FIG. 2, optionally conventional foodstuff 28 can be applied to the conventional coating material 24, in a manner to enhance the taste of the conventional coated food product 30. The term “foodstuff”, as used herein, is defined to mean any substance suitable for consumption as food. In the illustrated embodiment, the foodstuff 28 has the form of nut portions. However, in other embodiments the foodstuff 28 can have other forms including the non-limiting examples of candies, chocolate chips, chocolate swirls and the like.

Referring again to FIGS. 2 and 3, the conventional coated food product 30 includes a handle 32. A first end 34 of the handle 32 has been inserted through the outer skin 12, through an upper portion of the pulp portion 14 and into the inner core 16. In this manner, the handle 32 is securely attached to the food product 10. During the insertion process, the first end 34 of the handle 32 pierces the outer skin 12, thereby forming a discontinuous outer skin. In an installed arrangement, the handle 32 is configured for several functions. First, prior to application of the conventional coating material 24, the handle 32 is configured to secure the food product 10 as the coating material 24 is applied to the food product 10. After the coated food product 30 is formed, the handle 32 is configured to secure the coated food product 30 as the coated food product 30 is consumed.

In the embodiment illustrated in FIGS. 2 and 3, the handle 32 has the form of a wooden stick. However, in other embodiments, the handle 32 can have other forms, such as the non-limiting example of a plastic member, sufficient to be inserted into the food product 10 a sufficient distance such that a portion of the handle 32 lodges in the inner core 16.

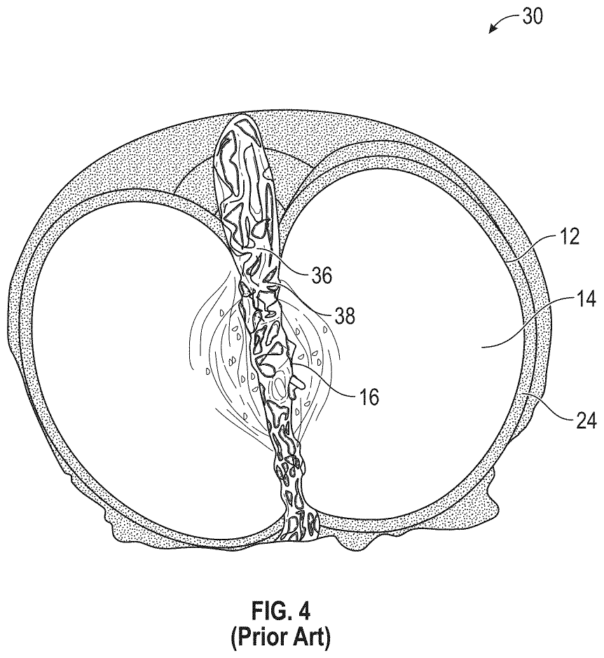

Referring now to FIG. 4, a cross-sectional view of an aged coated food product 30 is illustrated with the handle 32 having been removed. The coated food product 30 includes the outer skin 12, the pulp portion 14 located between the outer skin 12 and the inner core 16, the core 16 and the coating material 24 adjacent the exterior surface 26 of the outer skin 12.

Referring again to FIG. 4, in the process of inserting the first end 34 of the handle 32 into the coated food product 30, the first end 34 of the handle 32 pierces the outer skin 12 at a location 36 proximate the inner core 16. As the first end 34 of the handle 32 extends into the inner core 16, a passage 38 is formed by the handle 32. The passage 38 extends from the outer skin 12 to an area of the inner core 16. Without being held to the theory, it is believed degradation of the inner core 16 and an area of the pulp portion 14 adjacent the inner core 16 begins immediately upon piercing of the outer skin 12 and insertion of the handle 32 into the inner core 16. The degradation of the coated food product 30 continues until the coated food product 30 is consumed or discarded. The degradation of the coated food product 30 can cause a reduction in the shelf life of the coated food product 30. Without being held to the theory, it is believed the piercing of the outer skin 12 provides an entryway of degrading elements into the pulp portion 14 and the inner core 16 of the coated food product 30.

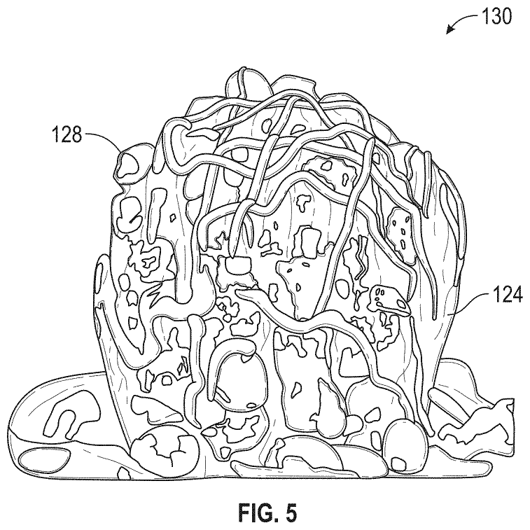

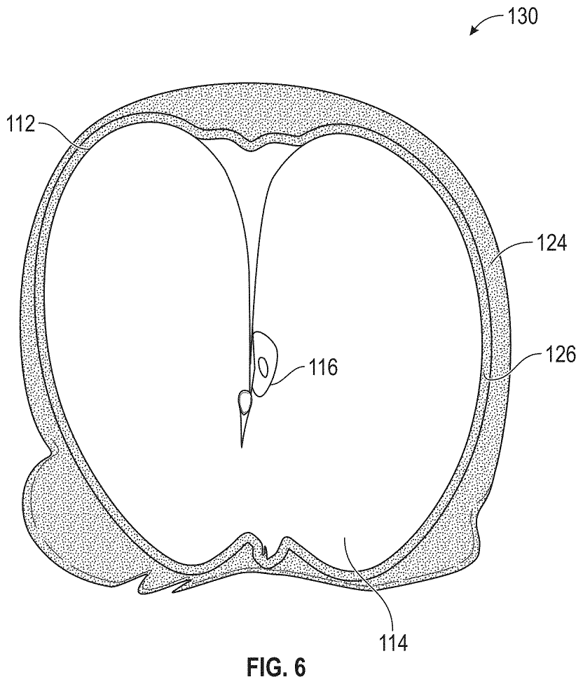

Referring now to FIGS. 5 and 6, an improved, coated, continuous outer-skinned food product 130 is illustrated. The term “continuous outer skin”, as used herein, is defined to mean the outer skin of the food product has not been pierced, and thereby provides an uninterrupted protective layer enveloping portions internal to the outer skin. The improved, coated, continuous outer skinned food product 130 includes an outer skin 112, a pulp portion 114 located between the outer skin 112 and an inner core 116 and a coating material 124 applied to an exterior surface 126 of the outer skin 112. It should be noted that the improved, coated, continuous outer-skinned food product 130 does not include a handle. Accordingly, the improved, coated, continuous outer-skinned food product 130 is formed without piercing the outer skin 112 with a stick or other handle-like structure. Since a handle is not used, a passage is not formed within the pulp portion 114, nor the inner core 116, of the coated, continuous outer-skinned food product 130. Without being held to the theory, it is believed the avoidance of piercing of the outer skin 112 and the subsequent lack of a passage formed by a handle eliminates an entryway of degrading elements into the interior of the coated, continuous outer-skinned food product 130. A comparison of the pierced food product 30, as shown in FIG. 3, with the coated, continuous outer skinned food product 130, as shown in FIGS. 5 and 6, with both food products produced at the same point in time, under the same production conditions and stored under the same conditions, provides the consideration that the coated, continuous outer skinned food product 130 has significantly less degradation than the food product 30 of FIG. 3. Accordingly and advantageously, it is believed the shelf life of the improved, coated, continuous outer skinned food product 130 is longer than the shelf life of a pierced coated food product, as shown in FIG. 2.

As a first non-limiting example, it has been found that the coated, continuous outer skinned food product 130 has a shelf-life of at least four weeks when held at room temperature as reported by the laboratory analysis shown in Table 1:

TABLE 1
Coated, Continuous Outer Skinned Food Product
Held 4 Weeks at Room Temperature

| Criteria | Value |
|---|---|
| Aerobic Plate Count per Coated, | 1,000 |
| Continuous Outer Skinned_Food Product ⁽¹⁾ | |
| Yeast per Coated, Continuous | <300 |
| Outer Skinned_Food Product ⁽²⁾ | |
| Mold per Coated, Continuous | <300 |
| Outer Skinned_Food Product ⁽²⁾ | |
| Lactic Acid Bacteria Group | <300 |
| per Coated, Continuous Outer | |
| Skinned_Food Product ⁽³⁾ | |

⁽¹⁾ As determined by Federal Food and Drug Administration Bacteriological Analytical Manual Chapter 3 Online Edition.
⁽²⁾ As determined by Federal Food and Drug Administration Bacteriological Analytical Manual Chapter 18 Online Edition.
⁽³⁾ As determined by American Public Health Association Compendium 4^{th} Edition 2001 19.527.

As a second non-limiting example, it has been found that the coated, continuous outer skinned food product 130 has a shelf-life of at least twelve weeks when refrigerated at a temperature of 4° C. as reported by the laboratory analysis shown in Table 2:

TABLE 2
Coated, Continuous Outer Skinned Food Product Held
12 Weeks at a Refrigerated Temperature of 4° C.

| Criteria | Value |
|---|---|
| Aerobic Plate Count per Coated, | <300 |
| Continuous Outer Skinned | |
| Food Product ⁽¹⁾ | |
| Coliform per Coated, Continuous | <300 |
| Outer Skinned Food Product ⁽²⁾ | |
| E. coli per Coated, Continuous | <300 |
| Outer Skinned Food Product ⁽³⁾ | |
| Salmonella per (3) Coated, Continuous | 0 |
| Outer Skinned Food Products ⁽⁴⁾ | |
| Yeast per Coated, Continuous | <300 |
| Outer Skinned Food Product ⁽⁵⁾ | |
| Mold per Coated, Continuous | <300 |
| Outer Skinned Food Product ⁽⁶⁾ | |
| Staphylococcus Coag. Positive | 0 |
| per (3) Coated, Continuous Outer | |
| Skinned Food Products ⁽⁷⁾ | |
| Lactic Acid Bacteria Group | <300 |
| per Coated, Continuous Outer | |
| Skinned Food Product ⁽⁸⁾ | |
| Listeria per Coated, Continuous | 0 |
| Outer Skinned Food Product ⁽⁹⁾ | |

⁽¹⁾ As determined by Federal Food and Drug Administration Bacteriological Analytical Manual Chapter 3 Online Edition.
⁽²⁾ As determined by Federal Food and Drug Administration Bacteriological Analytical Manual Chapter 4 Online Edition.
⁽³⁾ As determined by Federal Food and Drug Administration Bacteriological Analytical Manual Chapter 4A Online Edition.
⁽⁴⁾ As determined by Federal Food and Drug Administration Bacteriological Analytical Manual Chapter 5 Online Edition.
⁽⁵⁾ As determined by Federal Food and Drug Administration Bacteriological Analytical Manual Chapter 18 Online Edition.
⁽⁶⁾ As determined by Federal Food and Drug Administration Bacteriological Analytical Manual Chapter 18 Online Edition.
⁽⁷⁾ As determined by Federal Food and Drug Administration Bacteriological Analytical Manual Chapter 12 Online Edition.
⁽⁸⁾ As determined by American Public Health Association Compendium 4^{th} Edition 2001 19.527.
⁽⁹⁾ As determined by Federal Food and Drug Administration Bacteriological Analytical Manual Chapter 10 Online Edition.

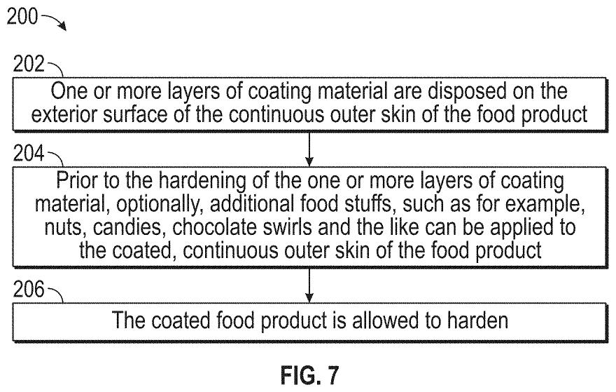

Referring now to FIG. 7, a process 200 for making the improved, coated, continuous outer-skinned food product 130 will now be described. In a first step 202, one or more layers of coating material 124 are disposed on the exterior surface 126 of the continuous outer skin 112 of the food product 130. The one or more layers of coating material 124 can be applied in any desired manner, including the non-limiting steps of dipping the food product 130, with a dipping mechanism, into one or more vessels containing the coating materials 124 and/or applying the one or more layers of coating materials with implements such as for example brushes or spatulas. One non-limiting example of a dipping mechanism is illustrated in pending U.S. patent application Ser. No. 16/176,492, filed Oct. 31, 2018 and titled “Food Product Gripping Apparatus”, the disclosure of which is incorporated herein by reference in its entirety. As described above, the application of the one or more layers of coating materials is accomplished without piercing the outer skin and without forming a passage within the pulp portion. Accordingly, the application of the one or more layers of coating material maintains the continuity of the outer skin 112 of the coated, continuous outer-skinned food product 130.

Referring again to FIG. 7, in an optional next step 204, prior to the hardening of the one or more layers of coating material 124, optionally, additional food stuffs 128, such as for example, nuts, candies, chocolate swirls and the like can be applied to the coated, continuous outer skin 112 of the food product 130.

Referring again to FIG. 7 in a final step 206, the one or more layers of coating material 124 coating the continuous outer-skinned food product 130 are allowed to harden.

The principle and mode of operation of the coated, continuous outer-skinned food product has been described in certain embodiments. However, it should be noted that the coated, continuous outer-skinned food product may be practiced otherwise than as specifically illustrated and described without departing from its scope.

What is claimed is:

1. A coated, continuous outer-skinned food product comprising:
an outer skin having an exterior surface;
a pulp portion internal to the outer skin;
an inner core internal to the pulp portion; and
one or more layers of coating materials applied to the exterior surface of the outer skin;
wherein the outer skin provides a continuous, uninterrupted protective layer enveloping the pulp portion and the inner core.

2. The coated, continuous outer-skinned food product of claim 1, wherein the coated, continuous outer-skinned food product is an apple.

3. The coated, continuous outer-skinned food product of claim 1, wherein one of the one or more layers of coating material is chocolate.

4. The coated, continuous outer skinned food product of claim 1, wherein one of the one or more foodstuffs can be applied to the one or more layers of coating material.

5. The coated, continuous outer skinned food product of claim 1, wherein the coated, continuous outer skinned food product has a shelf life of at least 4 weeks when stored at room temperature.

6. The coated, continuous outer skinned food product of claim 5, wherein the coated, continuous outer skinned food product has an aerobic plate count per coated, continuous outer skinned food product of about 1,000, as determined by the Chapter 3 of the Federal Food and Drug Administration Bacteriological Analytical Manual Online Edition.

7. The coated, continuous outer skinned food product of claim 5, wherein the coated, continuous outer skinned food product has yeast per coated, continuous outer skinned food product of less than about 300, as determined by Chapter 18 of the Federal Food and Drug Administration Bacteriological Analytical Manual Online Edition.

8. The coated, continuous outer skinned food product of claim 5, wherein the coated, continuous outer skinned food product has mold per coated, continuous outer skinned food product of less than about 300, as determined by Chapter 18 of the Federal Food and Drug Administration Bacteriological Analytical Manual Online Edition.

9. The coated, continuous outer skinned food product of claim 5, wherein the coated, continuous outer skinned food product has lactic acid bacteria group per coated, continuous outer skinned food product of less than about 300, as determined by the American Public Health Association Compendium 4^{th} Edition 2001 19.527.

10. The coated, continuous outer skinned food product of claim 1, wherein the coated, continuous outer skinned food product has a shelf life of at least 12 weeks when stored at a temperature of 4° C.

11. The coated, continuous outer skinned food product of claim 10, wherein the coated, continuous outer skinned food product has an aerobic plate count per coated, continuous outer skinned food product of less than about 300, as determined by Chapter 3 of the Federal Food and Drug Administration Bacteriological Analytical Manual Online Edition.

12. The coated, continuous outer skinned food product of claim 10, wherein the coated, continuous outer skinned food product has coliform of less than about 300, as determined by Chapter 4 of the Federal Food and Drug Administration Bacteriological Analytical Manual Online Edition.

13. The coated, continuous outer skinned food product of claim 10, wherein the coated, continuous outer skinned food product has E. coli of less than about 300, as determined by Chapter 4A of the Federal Food and Drug Administration Bacteriological Analytical Manual Online Edition.

14. The coated, continuous outer skinned food product of claim 10, wherein a quantity of three of the coated, continuous outer skinned food product has 0 Salmonella, as determined by Chapter 5 of the Federal Food and Drug Administration Bacteriological Analytical Manual Online Edition.

15. The coated, continuous outer skinned food product of claim 10, wherein the coated, continuous outer skinned food product has yeast per coated, continuous outer skinned food product of less than about 300, as determined by Chapter 18 of the Federal Food and Drug Administration Bacteriological Analytical Manual Online Edition.

16. The coated, continuous outer skinned food product of claim 10, wherein the coated, continuous outer skinned food product has mold per coated, continuous outer skinned food product of less than about 300, as determined by Chapter 18 of the Federal Food and Drug Administration Bacteriological Analytical Manual Online Edition.

17. The coated, continuous outer skinned food product of claim 10, wherein a quantity of three of the coated, continuous outer skinned food product has 0 Staphylococcus Coag., as determined by Chapter 12 of the Federal Food and Drug Administration Bacteriological Analytical Manual Online Edition.

18. The coated, continuous outer skinned food product of claim 10, wherein the coated, continuous outer skinned food product has lactic acid bacteria group per coated, continuous outer skinned food product of less than about 300, as determined by the American Public Health Association Compendium 4^{th} Edition 2001 19.527.

19. The coated, continuous outer skinned food product of claim 10, wherein the coated, continuous outer skinned food product has listeria per coated, continuous outer skinned food product of 0, as determined by Chapter 10 of the Federal Food and Drug Administration Bacteriological Analytical Manual Online Edition.
